(19) United States
(12) Patent Application Publication
(10) Pub. No.: US 2005/0153685 A1
(43) Pub. Date: Jul. 14, 2005

(54) Method of preventing loss of mobile communication terminals and recovering lost mobile communication terminals

(75) Inventor: Sang Baek Choi, Seoul (KR)

Correspondence Address: MERCHANT & GOULD PC, P.O. BOX 2903, MINNEAPOLIS, MN, 55402-0903, US

(73) Assignees: Ntracksystem Inc., Seoul (KR); Semyung IT Co., Ltd., Daegu-Si (KR)

(21) Appl. No.: 10/959,858

(22) Filed: Oct. 5, 2004

(30) Foreign Application Priority Data
Jan. 8, 2004 (KR) 2004-0001198

(51) Int. Cl. H04M 1/66; H04M 3/00; H04M 1/68; H04M 3/16; H04Q 7/20

(52) U.S. Cl. 455/411; 455/418; 455/410

(57) ABSTRACT

Disclosed herein is a method of preventing the loss of mobile communication terminals and recovering lost mobile communication terminals. The method of the present invention includes the steps of storing the personal information of an original owner of a mobile communication terminal and the unique information of the mobile communication terminal; examining the unique information of the mobile communication terminal; determining whether the unique information of the mobile communication terminal has been changed; and transmitting the changed unique information of the mobile communication terminal to the original owner if it is determined that, as a result of the determination, the unique information of the mobile communication terminal has been changed.

### BACKGROUND OF THE INVENTION

1. Field of the Invention

The present invention relates generally to a method of preventing the loss of mobile communication terminals and recovering lost mobile communication terminals using the unique information of the mobile communication terminals and, more particularly, to a method of preventing the loss and illegal use of mobile communication terminals and recovering lost mobile communication terminals in such a way as to transmit the changed unique information of lost mobile communication terminals to the original owners of the lost mobile communication terminals when mobile communication terminals are lost and finders attempt to use the lost mobile communication terminals after changing the unique information of the lost mobile communication terminals.

2. Description of the Related Art

According to Korean mobile communication companies, the number of lost mobile communication terminals was approximately 2.82 million in 2001. Of these lost terminals, 1.24 million terminals were not recovered. The resulting loss amounts to approximately 420 billion won each year.

As mobile communication terminals become more necessary and more miniaturized and thinned, the loss and theft of such mobile communication terminals are rapidly increasing. The lost mobile communication terminals that are not recovered may be illegally modified by the removal or alteration of the unique information of the mobile communication terminals (for example, the Electronic Serial Numbers (ESNs) of the mobile communication terminals), or the input of the duplicate unique information of some other mobile communication terminals, and be illegally circulated in black markets. Such illegally modified mobile communication terminals may be used for various crimes, such as fraud and intimidation. Furthermore, since the mobile communication terminals have short life spans, the mobile communication terminals must be abandoned if not recovered within certain period limits. In this case, resources are wasted and environmental pollution may occur. Additionally, recent mobile communication terminals are expensive and are used as a payment means for e-commerce in addition to a communication means, so that the loss of the mobile communication terminals may incur great damage to the properties of the original owners of the lost mobile communication terminals. Therefore, provisions for schemes for preventing the loss of mobile communication terminals and recovering lost mobile communication terminals are required.

As for one of the schemes for preventing the loss of mobile communication terminals and recovering lost mobile communication terminals, loss prevention devices using wireless communications have been commercialized. The loss prevention devices are operated in such a way that an alarm sound is issued when an alarm unit moves away from a reception unit by a predetermined distance or more. However, this scheme has a limitation in that it cannot perform its function if the alarm unit is spaced apart from the reception unit by a distance greater than that which allows wireless communications.

As for another scheme, a service, in which the ESNs of mobile phones are registered at a specific website, their finders search the website for the ESNs of lost mobile phones, and the lost mobile phones are recovered to the original owners of the mobile phones based on the search results, is being provided. However, in accordance with this scheme, the lost mobile phones cannot be recovered in the case where finders do not want to return the lost mobile phones or sell the lost mobile phones to brokers.

As for still another scheme, a service, in which, while lost mobile phones are turned on, the final locations of the lost mobile phones are determined and the original owners of the lost mobile phones are notified of the final locations of the mobile phones, exists. However, in this scheme, if the lost mobile phones are turned off or finders do not want to return lost mobile phones, the lost mobile phones cannot be recovered.

Another service, in which, when mobile phones are lost, notice messages related to the loss and recovery of the mobile phones are transmitted via a Short Message Service (SMS), is being provided.

However, since all the above-described services are dependent on the goodwill of finders, the services have limitations in that lost mobile communication terminals cannot be recovered if the finders do not return the lost mobile communication terminals voluntarily.

### SUMMARY OF THE INVENTION

Accordingly, the present invention has been made keeping in mind the above problems occurring in the prior art, and an object of the present invention is to provide a method that can prevent the loss of mobile communication terminals and recover lost mobile communication terminals in such a way as to transmit the changed unique information of the lost mobile communication terminals to the original owners of the lost mobile communication terminals if the lost mobile communication terminals are used after the unique information of the lost mobile communication terminals has been illegally changed.

In order to accomplish the above object, the present invention provides a method of preventing the loss of mobile communication terminals and recovering lost mobile communication terminals, including the steps of storing the personal information of an original owner of a mobile communication terminal and the unique information of the mobile communication terminal; examining the unique information of the mobile communication terminal; determining whether the unique information of the mobile communication terminal has been changed; and transmitting the changed unique information of the mobile communication terminal to the original owner if it is determined that, as a result of the determination, the unique information of the mobile communication terminal has been changed.

In accordance with another aspect of the present invention, there is provide a computer readable storage medium storing a program for implementing the functions of storing the personal information of an original owner of a mobile communication terminal and the unique information of the mobile communication terminal; examining the unique information of the mobile communication terminal; determining whether the unique information of the mobile communication terminal has been changed; and transmitting the changed unique information of the mobile communication terminal to the original owner if it is determined that, as a result of the determination, the unique information of the mobile communication terminal has been changed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram of a mobile communication terminal to which the present invention is applied;

FIG. 2 is a table showing an embodiment of data that is stored in the memory unit of the mobile communication terminal;

FIG. 3 is a schematic diagram showing an embodiment of a communication network to which the present invention is applied;

FIG. 4 is a flowchart showing a method of recovering lost mobile communication terminals using the unique information of the lost mobile communication terminals in accordance with an embodiment of the present invention; and

FIG. 5 is a flowchart showing a process of registering the personal information of the original owner of the mobile communication terminal and the unique information of the mobile communication terminal.

### DESCRIPTION OF THE PREFERRED EMBODIMENTS

Reference now should be made to the drawings, in which the same reference numerals are used throughout the different drawings to designate the same or similar components.

Prior to the description of the present invention, technical terms used in the present specification and claims are defined as follows. Terms other than the technical terms defined below have meanings that are used in the field to which the present invention pertains.

Definition

In the present invention, the term “mobile communication terminal” refers to any type of mobile communication terminal that can carry out mobile communications and access the wired/wireless Internet, such as a mobile phone and a Personal Digital Assistant (PDA).

In the present invention, the term “original owner's information device” refers to an information device that has a reception unit capable of receiving changed unique information from a lost mobile communication terminal, and includes a PDA, a notebook computer, a laptop computer, etc. The reception unit is one that can receive the information of a lost mobile communication terminal, and may be a telephone terminal receiving calls, a voice mailbox or a mobile phone capable of receiving short messages.

In the present invention, the term “communication network” refers to a general communication network, such as the Internet, a mobile communication network, or a Public Switched Telephone Network (PSTN).

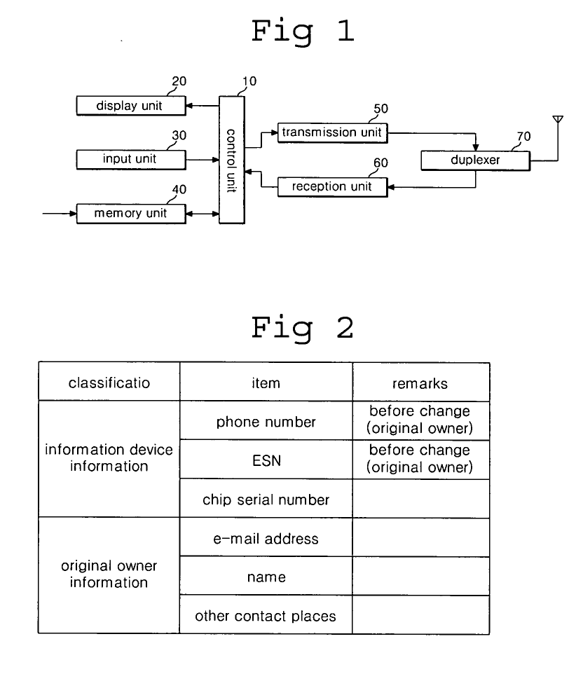

FIG. 1 is a schematic diagram of a mobile phone that is an embodiment of a mobile communication terminal to which a method of preventing the loss of mobile communication terminals and recovering lost mobile communication terminals in accordance with the present invention is applied. Referring to FIG. 1, a mobile communication terminal 1 includes a control unit 10, a transmission unit 50, a reception unit 60, a display unit 20, an input unit 30, a memory unit 40, a duplexer 70 and an antenna. The control unit 10 controls the entire operation of the mobile communication terminal 100 and, in particular, controls the transmission of the unique information of the mobile communication terminal to the original owner's information device 200 according to an embodiment of the present invention. The display unit 20 displays the operational status of the mobile communication terminal 100 under the control of the control unit 10. The input unit 30 outputs a key input signal, which corresponds to a key or keys pressed by the user, to the control unit 10. The memory unit 40 stores a control program for controlling the entire operation of the mobile communication terminal 100 according to the embodiment of the present invention, data created during the performance of the control operations, and data stored by the user. In particular, the first registered ESN of the mobile communication terminal 100, the unique information of the mobile communication terminal 100, such as a phone number at the time of first registration, and the original's owner personal information, such as the original owner's name, e-mail address and some other phone number, are stored in the memory unit 40. In the present invention, the control unit 10 and the memory unit 40 may be implemented so that the user cannot remove them and halt the operation thereof. The duplexer 70 outputs signals, which are received from the antenna, to the reception unit 60, and outputs signals, which are received from the transmission unit 50, to the antenna.

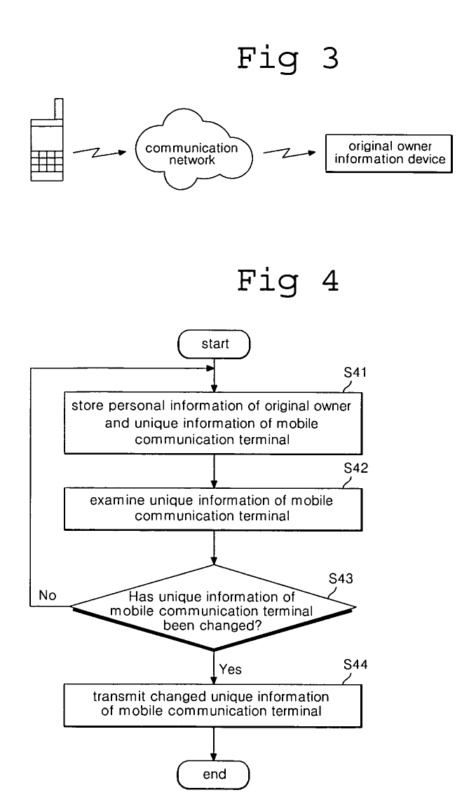

FIG. 2 is a table showing an embodiment of data that is stored in the memory unit of the mobile communication terminal. FIG. 3 is a schematic diagram showing an embodiment of a communication network on which the method of preventing the loss of mobile communication terminals and recovering lost mobile communication terminals according to the present invention can be performed. In the present invention, the memory unit 40 of the mobile communication terminal 100 stores the name of the original owner of the mobile communication terminal 100, the original owner's e-mail address, the original owner's phone number other than the phone number of the mobile communication terminal 100, and the ESN of the mobile communication terminal 100. The control unit 10 determines whether the unique information of the mobile communication terminal 100, such as the ESN or phone number of the mobile communication terminal 100, has been changed, and transmits the changed unique information of the mobile communication terminal 100 to the original owner's information device 200 via a communication network if the unique information has been changed.

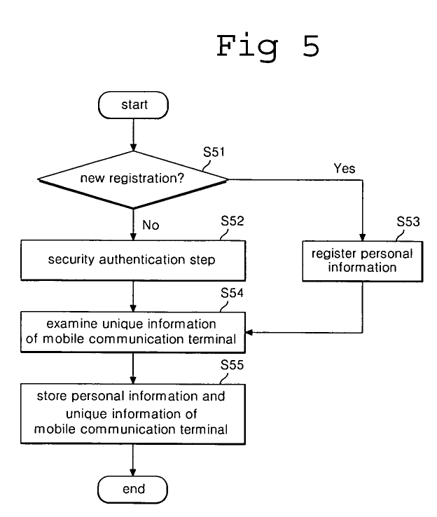

The method of preventing the loss of mobile communication terminals and recovering lost mobile communication terminals according to the present invention is described in detail with reference to FIGS. 4 and 5.

FIG. 4 is a flowchart showing a method of recovering lost mobile communication terminals using the unique information of the lost mobile communication terminals in accordance with an embodiment of the present invention.

In the present invention, the control unit 10 stores the personal information of the original owner of the mobile communication terminal 100 and the unique information of the mobile communication terminal 100 in the memory unit 40 at step S41. After the mobile communication terminal 100 has been lost, the control unit 10 examines the unique information of the mobile communication terminal 100 at step S42 and then determines whether the unique information of the mobile communication terminal 100 has been changed at step S43. If, as a result of the determination at step S43, it is determined that the unique information of the mobile communication terminal 100 has been changed, the control unit 10 transmits the changed unique information of the mobile communication terminal 100 to the original owner of the mobile communication terminal at step S44. In the present invention, in the case where a lost mobile communication terminal is obtained by some other person through a broker and then used, the original owner can recover the lost mobile communication terminal with reference to the changed unique information of the mobile communication terminal (the changed phone number or ESN of the mobile communication terminal). Even though the ESN of the mobile communication terminal is changed and then used, the original owner can recover the lost mobile communication terminal.

In order to perform the method of preventing the loss of mobile communication terminals and recovering lost mobile communication terminals, the personal information of the original owner and the unique information of the mobile communication terminal must be stored and registered in the memory unit 40 at the time of the opening of mobile communications. A method of registering the personal information of the original owner of the mobile communication terminal and the unique information of the mobile communication terminal is illustrated in FIG. 5, like step S41. In the process of registering the personal information of the original owner of the mobile communication terminal and the unique information of the mobile communication terminal, it is determined whether a registration is new at step S51. If the registration is new, the personal information of the original owner is received and stored at step S53. In contrast, if the registration is not new, the process goes through the security authentication step of determining whether a registered original owner makes access at step S52. The personal information may be updated when the personal information of the original owner is necessary after the security authentication step S52 (not shown). In the case where the information is legally changed after the security authentication step as described above, only the contents of the personal information stored in the memory unit 40 are updated, and the unnecessary information of the mobile communication terminal is not transmitted to the original owner because the control unit 10 determines that the ESN or phone number of the mobile communication terminal has not been changed.

After the personal information of the original owner of the mobile communication terminal has been registered, the unique information stored in the mobile communication terminal is read at step S54. The unique information of the mobile communication terminal includes the ESN, phone number and chip serial number of the mobile communication terminal. Thereafter, the read unique information of the mobile communication terminal is stored in the memory unit 40 at step S55, and it is determined whether the unique information of the mobile communication terminal has been changed by comparing the registered unique information with the changed unique information in the case where the mobile communication terminal is lost and the unique information has been changed.

In the present invention, the step s43 of determining whether the unique information of the mobile communication terminal has been changed may be constructed to include the step of determining whether the phone number of the mobile communication terminal has been changed and the step of determining whether the ESN of the mobile communication terminal has been changed if the phone number of the mobile communication terminal has not been changed. In another embodiment of the present invention, after it is determined whether the ESN of the mobile communication terminal has been changed, it may be determined whether the phone number of the mobile communication terminal has been changed.

In the present invention, the unique information of the mobile communication terminal includes one or more selected from the ESN, phone number and chip serial number of the mobile communication terminal.

In the present invention, the personal information of the original owner stored in the memory unit 40 may include a name, an address, and an e-mail address or some other phone number that is used to receive the changed unique information of the mobile communication terminal from the mobile communication terminal.

In the present invention, in the case where it is determined that the unique information of the mobile communication terminal has been changed, the unique information of the mobile communication terminal, including the ESN and phone number of the mobile communication terminal, can be transmitted to the original owner via one of various means. For example, the changed unique information may be transmitted to the e-mail address of the original owner, which was stored in the memory unit 40, via e-mail.

Another aspect of the present invention provides a storage medium that stores a program for implementing the method of preventing the loss of mobile communication terminals and recovering lost mobile communication terminals. This storage medium stores a program for implementing a function of storing the personal information of the original owner of a mobile communication terminal and the unique information of the mobile communication terminal, a function of examining the unique information of the mobile communication terminal, a function of determining whether the unique information of the mobile communication terminal has been changed, and a function of transmitting the changed unique information of the mobile communication terminal to the original owner if it is determined that the unique information of the mobile communication terminal has been changed. Furthermore, in order to implement the function of storing the personal information of the original owner of a mobile communication terminal and the unique information of the mobile communication terminal, the storage medium may be one that stores a program for implementing a function of determining whether a registration is new, a security authentication function of receiving and storing the personal information of the original owner if it is determined that the registration is new and determining whether a registered original owner makes access if it is determined that the registration is not new, a function of reading the unique information of the mobile communication terminal, and a function of storing the read unique information of the mobile communication terminal in the memory unit.

As described above, the method of preventing the loss of mobile communication terminals and recovering lost mobile communication terminals allows the original owners of the mobile communication terminals to recover the lost mobile communication terminals by notifying the original owners of the changed information of the lost mobile communication terminals, so that the method has an effect in that the illegal modification of the lost mobile communication terminals can be prevented. Furthermore, the method of the present invention can be stored in the memory units of the mobile communication terminals, so that the method can be implemented without additional expenses incurred by the purchase of additional devices or insurance contracts. Furthermore, the present invention is remarkably advantageous in that lost mobile communication terminals can be easily tracked and recovered using e-mail that is available everywhere in the world, in the case where finders do not track the original owners of the lost mobile communication terminals, do not hand over the lost mobile communication terminals to the original owners, and illegally modify and use the lost mobile communication terminals or illegally modify and use the lost mobile communication terminals through brokers, thus solving problems related to the use of the lost terminals in crimes, resource waste and environmental pollution.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of preventing loss of mobile communication terminals and recovering lost mobile communication terminals, comprising the steps of:
storing personal information of an original owner of a mobile communication terminal and unique information of the mobile communication terminal;
examining the unique information of the mobile communication terminal;
determining whether the unique information of the mobile communication terminal has been changed; and
transmitting changed unique information of the mobile communication terminal to the original owner if it is determined that, as a result of the determination, the unique information of the mobile communication terminal has been changed.

2. The method as set forth in claim 1, wherein the step of storing the personal information of the original owner of the mobile communication terminal and the unique information of the mobile communication terminal comprises the steps of:
determining whether a registration is new;
receiving and storing the personal information of the original owner if the registration is new, and determining whether a registered original owner makes access if the registration is not new;
reading the unique information of the mobile communication terminal; and
storing the unique information of the mobile communication terminal in memory.

3. The method as set forth in claim 1, wherein the unique information of the mobile communication terminal includes one or more selected from an Electronic Serial Number (ESN), an phone number and a chip serial number of the mobile communication terminal.

4. The method as set forth in claim 1, wherein the step of determining whether the unique information of the mobile communication terminal has been changed comprises the steps of:
determining whether a phone number of the mobile communication terminal has been changed; and
determining whether an ESN of the mobile communication terminal has been changed if the phone number of the mobile communication terminal has not been changed.

5. The method as set forth in claim 1, wherein the personal information of the original owner includes a name, and an e-mail address that is used to receive the changed unique information of the mobile communication terminal from the mobile communication terminal, or some other phone number.

6. The method as set forth in claim 1, wherein the step of transmitting the changed unique information of the mobile communication terminal to the original owner includes the step of transmitting the changed ESN and phone number of the mobile communication terminal to the original owner via e-mail.

7. A computer readable storage medium storing a program for implementing the functions of:
storing personal information of an original owner of a mobile communication terminal and unique information of the mobile communication terminal;
examining the unique information of the mobile communication terminal;
determining whether the unique information of the mobile communication terminal has been changed; and
transmitting changed unique information of the mobile communication terminal to the original owner if it is determined that, as a result of the determination, the unique information of the mobile communication terminal has been changed.

8. The computer readable storage medium as set forth in claim 7, wherein, to implement the function of storing the personal information of the original owner of the mobile communication terminal and the unique information of the mobile communication terminal, the computer readable storage medium further stores a program for implementing the functions of:
determining whether a registration is new;
receiving and storing the personal information of the original owner if the registration is new, and determining whether a registered original owner makes access if the registration is not new;
reading the unique information of the mobile communication terminal; and
storing the unique information of the mobile communication terminal in memory.
